(19) United States
(12) Patent Application Publication
(10) Pub. No.: US 2019/0222725 A1
(43) Pub. Date: Jul. 18, 2019

(54) CAMERA DEVICE

(71) Applicant: Yuhua WANG, Beijing (CN)

(72) Inventor: Yuhua WANG, Beijing (CN)

(21) Appl. No.: 16/329,748

(22) PCT Filed: Sep. 19, 2017
(86) PCT No.: PCT/CN2017/102253

§ 371 Date: Feb. 28, 2019

(30) Foreign Application Priority Data
Sep. 27, 2016 (CN) 201621080353.8

(51) Int. Cl. H04N 5/225; H04N 5/232; H04N 7/18; H05B 37/02

(52) U.S. Cl. CPC H04N 5/2252; H04N 5/232; H05B 37/0227; H04N 5/2256; H04N 7/185

(57) ABSTRACT

A camera device includes a camera case provided with a camera lens, a steering device configured to steer the camera case, an image signal transmitting device configured to transmit an image signal captured by the camera lens to an image display or recording device, and a power supply device configured to supply power to the camera device. The power supply device includes an electric plug configured to obtain an AC power supply of 100 to 240 volts and an associated transformer-rectifier device. An LED illumination device is disposed on the camera case. The image signal transmitting device is a wireless transmitting device.

### CROSS-REFERENCE TO RELATED APPLICATION

This application is a national stage of International Application No. PCT/CN2017/102253 filed on Sep. 19, 2017, which claims priority to Chinese Utility Model Application No. 201621080353.8, filed on Sep. 27, 2016 and titled “CAMERA DEVICE”, the entirety of all which are incorporated herein by reference.

### TECHNICAL FIELD

The present disclosure relates to a camera device for indoor and outdoor monitoring.

### BACKGROUND

Camera devices for indoor and outdoor monitoring have been widely used. Existing camera devices require a bracket at the installation site and are secured by fasteners. It is also very troublesome to change the position of the camera device.

### SUMMARY

An object of the present disclosure is to overcome the defects in the background art by providing a camera device including a camera case provided with a camera lens, a steering device configured to steer the camera case, an image signal transmitting device configured to transmit an image signal captured by the camera lens to an image display or recording device, and a power supply device configured to supply power to the camera device, wherein the power supply device includes an electric plug configured to obtain an AC power supply of 100 to 240 volts and an associated transformer-rectifier device.

The image signal transmitting device configured to transmit the image signal captured by the camera lens to the image display or recording device may be a wireless transmitting device.

The image signal transmitting device configured to transmit the image signal captured by the camera lens to the image display or recording device may be connected via a wire or lead.

The steering device configured to steer the camera case may be a horizontal steering device, a vertical steering device, or an omnidirectional universal steering device.

Another object of the present disclosure is to provide a camera device including a camera case provided with a camera lens, a steering device configured to steer the camera case, an image signal transmitting device configured to transmit an image signal captured by the camera lens to an image display or recording device, and a power supply device configured to supply power to the camera device, wherein the power supply device includes an electric plug configured to obtain an AC power supply of 100 to 240 volts and an associated transformer-rectifier device; and a light-emitting diode (LED) lamp illumination device is disposed on the camera case.

The image signal transmitting device configured to transmit the image signal captured by the camera lens to the image display or recording device may be a wireless transmitting device.

The image signal transmitting device configured to transmit the image signal captured by the camera lens to the image display or recording device may be connected via a wire or lead.

The steering device configured to steer the camera case may be a horizontal steering device, a vertical steering device, or an omnidirectional universal steering device.

The LED illumination device disposed on the camera case may include a device configured to control on-off of the LED lamp.

The device configured to control on-off of the LED lamp may have a device configured to turn on the LED lamp when the camera lens detects a moving object, and turn off the LED lamp when no moving object is detected within a set time interval.

The device configured to control on-off of the LED lamp may have a device configured to turn on the LED lamp when the camera lens detects infrared radiation higher than the surroundings, and turn off the LED lamp when no infrared radiation higher than the surroundings is detected within a set time interval.

The camera device of the disclosure is simple to install and use, convenient to move, and especially suitable for monitoring devices for homes, small buildings and temporary installations.

### BRIEF DESCRIPTION OF DRAWINGS

FIGS. 1, 2 and 3 respectively show a camera device according to the first embodiment of the present disclosure. FIG. 1 is a perspective view, FIG. 2 is a plan view, and FIG. 3 is a side view.

FIGS. 4, 5 and 6 respectively show a camera device according to the second embodiment of the present disclosure. FIG. 4 is a perspective view, FIG. 5 is a plan view, and FIG. 6 is a side view.

### DETAILED DESCRIPTION

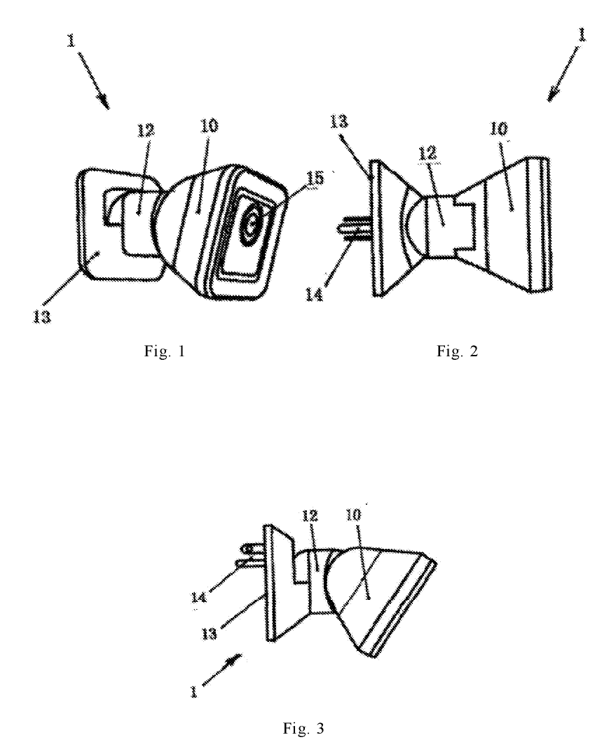

FIG. 1 is a perspective view of a camera device 1 of the first embodiment of the present disclosure. The camera device includes a camera case 10, a steering device 12, and an electric plug 13 for obtaining power supply. The camera case 10 is provided with a camera lens 15 thereon.

FIG. 2 is a plan view of the camera device 1 of the first embodiment of the present disclosure, and FIG. 3 is a side view thereof. It can be seen from these figures that the electric plug 13 has an electric pin 14.

As shown in FIGS. 1 to 3, the camera lens 15 on the camera case 10 captures an image, which is transmitted by an image signal wireless transmitting device (not shown) within the camera case to an image display or recording device within a preset distance for monitoring. Instead of wireless transmission, a wired connection via a wire or lead may also be used.

The steering device 12 is disposed between the camera case 10 and the electric plug 13 for obtaining power supply. The steering device 12 may be a clip-type steering device for varying a horizontal viewing angle, or an angle of elevation or depression, of the camera lens 15. The steering device 12 may also be a universal steering device, such as a ball-and-socket universal joint.

As can be seen from FIGS. 2 and 3, the electric plug 13 for obtaining power supply has an electric pin 14, which may be directly plugged into a common electric socket of 100-240V (AC) to obtain power supply on one hand, and, on the other hand, to install and secure the entire camera device 1 at a working position by a fixing force of the electric pin 14 inserted into the electric socket. After obtaining a power supply of 100 to 240 V (AC), a suitable transformer-rectifier device is required to supply a suitable DC power supply for the camera and the transmitting device. This transformer-rectifier device (not shown) may be provided in the camera case 10 or in the electric plug 13 (by expanding a space within the electric plug).

Since the entire camera device 1 is installed and fixed at the working position by the pin of the electric plug, the camera device of the present disclosure is easy to use without any mounting bracket or fastener. It is also convenient to remove or change the position of the device.

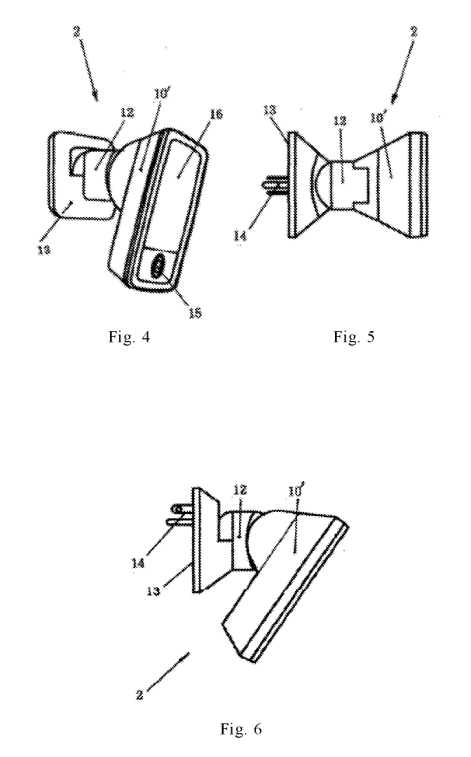

FIGS. 4, 5 and 6 show a camera device 2 according to the second embodiment of the present disclosure. FIG. 4 is a perspective view, FIG. 5 is a plan view, and FIG. 6 is a side view.

The camera device 2 is very similar to the camera device 1 of the first embodiment. The same features of the camera devices 1 and 2 are not repeated here, but their difference lies in that the camera case 10′ of the camera device 2 is different from that of the camera device 1. The camera case 10′ has a larger volume, and a front surface thereof for disposing the camera lens 15 has a larger area to arrange the LED illumination device 16. At the same time, a control device for controlling on-off of the LED illumination device 16 is provided in the camera case 10′.

The device for controlling on-off of the LED illumination device 16 is a device configured such that the LED lamp is turned on when the camera lens detects a moving object, and turned off when no moving object is detected within a set time interval. It may also be a device configured such that the LED lamp is turned on when the camera lens detects infrared radiation higher than the surroundings, and turned off when no infrared radiation higher than the surroundings is detected within a set time interval. The set time interval may be fixed or adjustable (the control device thereof is not shown). Obviously, the camera device 2 is more convenient to use and has a better security effect.

The camera device of the disclosure has the advantages of being simple to install and use, convenient to move, and especially suitable for monitoring devices for homes, small buildings and temporary installations.

What is claimed is:

1. A camera device, characterized in that the camera device comprising:
a camera case provided with a camera lens;
a steering device configured to steer the camera case;
an image signal transmitting device configured to transmit an image signal captured by the camera lens to an image display or recording device; and
a power supply device configured to supply power to the camera device,
wherein the power supply device includes an electric plug configured to obtain an AC power supply of 100 to 240 volts and a transformer-rectifier device.

2. The camera device according to claim 1, wherein the image signal transmitting device configured to transmit the image signal captured by the camera lens to the image display or recording device is a wireless transmitting device.

3. The camera device according to claim 1, wherein the image signal transmitting device configured to transmit the image signal captured by the camera lens to the image display or recording device is connected via a wire or lead.

4. The camera device according to claim 1, wherein the steering device configured to steer the camera case is a horizontal steering device, a vertical steering device, or an omnidirectional universal steering device.

5. A camera device, comprising:
a camera case provided with a camera lens;
a steering device configured to steer the camera case;
an image signal transmitting device configured to transmit an image signal captured by the camera lens to an image display or recording device; and
a power supply device configured to supply power to the camera device,
wherein the power supply device includes an electric plug for obtaining an AC power supply of 100 to 240 volts and a transformer-rectifier device, and an LED lamp illumination device is disposed on the camera case.

6. The camera device according to claim 5, wherein the image signal transmitting device configured to transmit the image signal captured by the camera lens to the image display or recording device is a wireless transmitting device.

7. The camera device according to claim 5, wherein the image signal transmitting device configured to transmit the image signal captured by the camera lens to the image display or recording device is connected via a wire or lead.

8. The camera device according to claim 5, wherein the steering device configured to steer the camera case is a horizontal steering device, a vertical steering device, or an omnidirectional universal steering device.

9. The camera device according to claim 5, wherein the LED illumination device disposed on the camera case includes a device configured to control on-off of the LED lamp.

10. The camera device according to claim 9, wherein the device configured to control on-off of the LED lamp has a device configured to turn on the LED lamp in a case where the camera lens detects a moving object, and turn off the LED lamp in a case where no moving object is detected within a set time interval;
or, the device configured to control on-off of the LED lamp has a device configured to turn on the LED lamp in a case where the camera lens detects infrared radiation higher than the surroundings, and turn off the LED lamp in a case where no infrared radiation higher than the surroundings is detected within a set time interval.
